(19) United States
(12) Patent Application Publication
(10) Pub. No.: US 2026/0251360 A1
(43) Pub. Date: Aug. 27, 2026

(54) CRYOGENIC DEVICE

(71) Applicant: SUMITOMO HEAVY INDUSTRIES, LTD., Tokyo (JP)

(72) Inventor: Kenta DEMURA, Yokosuka-shi (JP)

(21) Appl. No.: 19/649,237

(22) Filed: Apr. 16, 2026

Related U.S. Application Data
(63) Continuation of application No. PCT/JP2024/040986, filed on Nov. 19, 2024.

(30) Foreign Application Priority Data
Dec. 13, 2023 (JP) 2023-210304

(51) Int. Cl. F25B 9/10; F25B 9/14

(52) U.S. Cl. CPC F25B 9/10; F25B 9/14

(57) ABSTRACT

A cryogenic device includes a cryocooler including a first cooling stage and a second cooling stage that are disposed along a center axis of the cryocooler, in which the second cooling stage is cooled to a lower temperature than the first cooling stage, and a heat switch that thermally connects the first cooling stage and the second cooling stage to each other or that disconnects the thermal connection between the first cooling stage and the second cooling stage, the heat switch extending along a direction that is not parallel to the center axis of the cryocooler.

### CROSS-REFERENCE TO RELATED APPLICATIONS

This is a bypass continuation of International PCT Application No. PCT/JP2024/040986, filed on November 19, 2024, which claims priority to Japanese Patent Application No. 2023-210304, filed on December 13, 2023, which are incorporated by reference herein in their entirety.

### BACKGROUND

### Technical Field

Certain embodiments of the present invention relate to a cryogenic device.

### Description of Related Art

For example, in a cryogenic device that operates at a cryogenic temperature, such as a superconducting magnet device, initial cooling is performed to cool the device from an initial temperature such as room temperature to a target cooling temperature when the device is started up.

### SUMMARY

One or more embodiments provide a cryogenic device including: a cryocooler including a first cooling stage and a second cooling stage that are disposed along a center axis of the cryocooler, in which the second cooling stage is cooled to a lower temperature than the first cooling stage; and a heat switch that thermally connects the first cooling stage and the second cooling stage to each other or that disconnects the thermal connection between the first cooling stage and the second cooling stage, the heat switch extending along a direction that is not parallel to the center axis of the cryocooler.

One or more embodiments provide a cryogenic device including: a cryocooler including a first cooling stage and a second cooling stage, in which the second cooling stage is cooled to a lower temperature than the first cooling stage; and a heat switch that thermally connects the first cooling stage and the second cooling stage to each other or that disconnects the thermal connection between the first cooling stage and the second cooling stage, the heat switch extending along a direction that is different from a direction of gravity acting on the cryogenic device.

One or more embodiments provide a cryogenic device including: a cryocooler that includes a first cooling stage and a second cooling stage, in which the second cooling stage is cooled to a lower temperature than the first cooling stage; a heat switch that thermally connects the first cooling stage and the second cooling stage to each other or that disconnects the thermal connection between the first cooling stage and the second cooling stage; and a rotatable vacuum vessel in which the cryocooler is installed and in which the heat switch is accommodated together with the first cooling stage and the second cooling stage.

### BRIEF DESCRIPTION OF THE DRAWINGS

FIG. 1 is a view schematically showing a cryogenic device according to an embodiment.

FIG. 2 is a schematic cross-sectional view showing an exemplary configuration of a heat switch according to the embodiment in more detail.

FIG. 3 is a schematic view showing a heat switch according to a modification example.

FIGS. 4A and 4B are schematic views showing a heat switch according to a modification example.

FIG. 5 is a schematic view showing a heat switch according to a modification example.

FIG. 6 is a schematic view showing a heat switch according to a modification example.

FIG. 7 is a schematic view showing a heat switch according to a modification example.

FIG. 8 is a schematic view showing a heat switch device according to an embodiment.

FIG. 9 is a view schematically showing a cryogenic device according to another embodiment.

FIG. 10 is a view schematically showing a cryogenic device according to another embodiment.

FIG. 11 is a view schematically showing a cryogenic device according to another embodiment.

### DETAILED DESCRIPTION

Use of the cryogenic device, such as provision of a high magnetic field by a superconducting magnet, becomes possible after completion of the initial cooling. Therefore, it is desired that a time required for the initial cooling be as short as possible.

It is desirable to shorten a time required for initial cooling in a cryogenic device.

Hereinafter, an embodiment for carrying out the present invention will be described in detail with reference to the drawings. In the description and the drawings, the same or equivalent components, members, and processes will be denoted by the same reference numerals, and overlapping descriptions will be omitted as appropriate. The scale or shape of each part that is shown in the drawings is conveniently set for ease of description and should not be interpreted as limiting unless otherwise specified. The embodiment is merely an example and does not limit the scope of the present invention in any way. All of the features described in the embodiments and combinations thereof are not necessarily essential to the invention.

FIG. 1 is a view schematically showing a cryogenic device 10 according to an embodiment. The cryogenic device 10 is configured to cool a superconducting coil 12, which is an example of an object to be cooled, from room temperature to a cryogenic temperature, and to maintain the superconducting coil 12 at the cryogenic temperature during use of the superconducting coil 12.

The superconducting coil 12 is mounted as a magnetic field source in high magnetic field utilization equipment (not shown), for example, a single crystal pulling device, an NMR system, an MRI system, an accelerator such as a cyclotron, a high-energy physics system such as a nuclear fusion system, or other high magnetic field utilization equipment, and can generate a high magnetic field required for the equipment. The superconducting coil 12 is configured to generate a strong magnetic field by energizing the superconducting coil 12 in a state of being cooled to a cryogenic temperature equal to or lower than a superconducting transition temperature.

The cryogenic device 10 includes a cryocooler 20, a vacuum vessel 30, a radiation shield 40, and a heat switch 100.

The cryocooler 20 is a two-stage Gifford-McMahon (GM) cryocooler in the present embodiment. The cryocooler 20 includes a compressor 21 and a two-stage cold head 22.

The compressor 21 is configured to recover a refrigerant gas of the cryocooler 20 from the cold head 22, to increase a pressure of the recovered refrigerant gas, and to supply the refrigerant gas to the cold head 22 again. The cold head 22 is also referred to as an expander, and can generate cooling by adiabatically expanding the supplied refrigerant gas in an internal expansion chamber. The circulation of the refrigerant gas between the compressor 21 and the cold head 22 is performed with a combination of appropriate pressure fluctuations and volume fluctuations of the refrigerant gas in the cold head 22, thereby constituting a refrigeration cycle (for example, a GM cycle) of the cryocooler 20, and thus each cooling stage of the cold head 22 is cooled to a desired cryogenic temperature. The refrigerant gas is also referred to as a working gas and is usually helium gas, but other appropriate gases may be used.

The cold head 22 includes a cold head flange 23, a first cylinder 24a, a first cooling stage 25a, a second cylinder 24b, and a second cooling stage 25b, and these are disposed coaxially along a center axis C1 of the cryocooler 20. The center axis C1 can also be referred to as a center axis of the cold head 22.

The first cylinder 24a connects the cold head flange 23 to the first cooling stage 25a, and the second cylinder 24b connects the first cooling stage 25a to the second cooling stage 25b. The first cooling stage 25a and the second cooling stage 25b are formed of, for example, a high thermal conductivity metal such as copper (for example, pure copper) or another thermally conductive material. The first cylinder 24a and the second cylinder 24b are formed of, for example, a metal such as stainless steel. In general, the thermal conductivity of the thermally conductive material forming the cooling stage is higher than the thermal conductivity of the material forming the cylinder.

In addition, the cold head 22 includes a cold head driver 26. The cold head driver 26 is attached to the cold head flange 23. The cold head driver 26 includes a motor that reciprocates a first displacer and a second displacer accommodated in the first cylinder 24a and the second cylinder 24b, respectively, in an axial direction. In addition, the cold head driver 26 also accommodates a pressure switching valve that is driven in synchronization with the displacer by the motor. The pressure switching valve is configured to periodically switch between receiving a high-pressure refrigerant gas and delivering a low-pressure refrigerant gas to the cold head 22.

In the illustrated example, the cold head 22 is installed on a top plate of the vacuum vessel 30. An opening is provided in the top plate of the vacuum vessel 30, and the cold head 22 is inserted into the vacuum vessel 30 from the opening. The cold head flange 23 is attached to the vacuum vessel 30 through the opening, and the cold head 22 is fixed to the vacuum vessel 30. The first cylinder 24a, the first cooling stage 25a, the second cylinder 24b, and the second cooling stage 25b of the cold head 22 are disposed in the vacuum vessel 30. The cold head 22 is vertically installed in the vacuum vessel 30 such that the cold head driver 26 faces upward and the first cooling stage 25a and the second cooling stage 25b face downward.

Therefore, the cold head 22 is installed in the vacuum vessel 30 such that the center axis C1 coincides with a direction of gravity (up-down direction in FIG. 1) acting on the cryogenic device 10. Such a disposition of the cryocooler 20 is typical, but other mounting postures are also possible. The cryocooler 20 may be installed in the vacuum vessel 30 such that the center axis C1 is directed in a horizontal direction or in another direction.

The first cooling stage 25a and the second cooling stage 25b are cooled to desired cryogenic temperatures by the operation of the cryocooler 20. The first cooling stage 25a is cooled to a first cooling temperature, for example, 30 K to 80 K, and the second cooling stage 25b is cooled to a second cooling temperature lower than the first cooling temperature, for example, 3 K to 20 K. The second cooling temperature is a temperature lower than a superconducting transition temperature of the superconducting coil 12.

In FIG. 1, for example, one cryocooler 20 is shown, but the cryogenic device 10 may include a plurality of cryocoolers 20 that cool the same object to be cooled, as necessary, for example, in a case where the superconducting coil 12 is large.

The vacuum vessel 30 is configured to separate a vacuum region 32 from an external environment (for example, a room temperature atmospheric pressure environment) 14. The vacuum region 32 is defined in the vacuum vessel 30. The vacuum vessel 30 may be, for example, a cryostat. The superconducting coil 12, the first cooling stage 25a and the second cooling stage 25b of the cryocooler 20, the radiation shield 40, and the heat switch 100 are disposed in the vacuum region 32 and are vacuum-insulated from the external environment 14. The compressor 21, the cold head flange 23, and the cold head driver 26 of the cryocooler 20 are disposed in the external environment 14.

The cryogenic device 10 is configured as a conduction-cooled type in which an object to be cooled (for example, the radiation shield 40 and the superconducting coil 12) is directly cooled by the cryocooler 20. The cryocooler 20 is thermally coupled to the object to be cooled to cool the object to be cooled by conduction cooling.

The radiation shield 40 is thermally coupled to the first cooling stage 25a and is cooled to the first cooling temperature. The radiation shield 40 is directly attached to the first cooling stage 25a and is thermally coupled to the first cooling stage 25a. Alternatively, the radiation shield 40 may be attached to the first cooling stage 25a via a heat transfer member having flexibility or rigidity. The radiation shield 40 is disposed to surround the superconducting coil 12, the second cooling stage 25b of the cryocooler 20, and other low-temperature sections that are to be cooled to the second cooling temperature, and can thermally protect these low-temperature sections from radiant heat from the outside. The radiation shield 40 is formed of a metal material such as copper or other materials having a high thermal conductivity.

The superconducting coil 12 is thermally coupled to the second cooling stage 25b via a heat transfer member 50. The heat transfer member 50 is formed of, for example, a metal material such as copper or another material having a high thermal conductivity, and connects the superconducting coil 12 to the second cooling stage 25b. The heat transfer member 50 may flexibly connect the superconducting coil 12 and the second cooling stage 25b to allow relative displacement between them, or may be a rigid member that rigidly connects the superconducting coil 12 and the second cooling stage 25b. The heat transfer member 50 is formed of, for example, a metal material such as copper or another material having a high thermal conductivity.

In the illustrated example, the heat transfer member 50 is fixed to a bottom surface of the second cooling stage 25b, but may be fixed to another portion such as a side surface or an upper surface of the second cooling stage 25b. Similarly, the heat transfer member 50 is fixed to, for example, a bottom surface of the superconducting coil 12, but may be fixed to another portion such as a side surface or an upper surface of the superconducting coil 12.

The heat switch 100 is configured to thermally connect the first cooling stage 25a and the second cooling stage 25b to each other or to disconnect the thermal connection between the first cooling stage 25a and the second cooling stage 25b. In other words, the heat switch 100 is configured to thermally connect a portion at the first cooling temperature (for example, the radiation shield 40) and a portion at the second cooling temperature (for example, the superconducting coil 12) in the cryogenic device 10, or to disconnect the thermal connection between these portions.

In the present embodiment, the heat switch 100 extends along a direction that is not parallel to the center axis C1 of the cryocooler 20. That is, a center axis C2 of the heat switch 100 is not parallel to the center axis C1 of the cryocooler 20. Since the center axis C1 of the cryocooler 20 is parallel to the direction of gravity acting on the cryogenic device 10 as described above, the center axis C2 of the heat switch 100 extends along a direction different from the direction in which gravity acts on the cryogenic device 10.

As an example, as illustrated, the heat switch 100 extends along a direction perpendicular to the center axis C1 of the cryocooler 20. In a case where the center axis C1 of the cryocooler 20 is parallel to the direction of gravity, the center axis C2 of the heat switch 100 extends in the horizontal direction.

The heat switch 100 is a so-called gas-gap type heat switch. The heat switch 100 includes a first heat transfer element (hereinafter, also referred to as a high-temperature-side heat transfer element) 110 and a second heat transfer element (hereinafter, also referred to as a low-temperature-side heat transfer element) 120 that are disposed to face each other with a gas gap 130 interposed therebetween. The high-temperature-side heat transfer element 110 has a first heat transfer surface 71 that faces the gas gap 130 and that extends along the center axis C2 of the heat switch 100. The low-temperature-side heat transfer element 120 has a second heat transfer surface 72 that faces the gas gap 130 and that extends along the center axis C2 of the heat switch 100. The high-temperature-side heat transfer element 110 is thermally coupled to the first cooling stage 25a, and the low-temperature-side heat transfer element 120 is thermally coupled to the second cooling stage 25b.

The high-temperature-side heat transfer element 110 is attached to any portion that is cooled to the first cooling temperature, and the low-temperature-side heat transfer element 120 is attached to any portion that is cooled to the second cooling temperature. As illustrated, the high-temperature-side heat transfer element 110 may be attached to a first member 61, and the low-temperature-side heat transfer element 120 may be attached to a second member 62. The first member 61 is attached to the radiation shield 40 and is thermally coupled to the first cooling stage 25a. The second member 62 is attached to the heat transfer member 50 and is thermally coupled to the second cooling stage 25b. The first member 61 and the second member 62 are formed of, for example, a metal material such as copper or other materials having a high thermal conductivity, similarly to the radiation shield 40 and the heat transfer member 50. Alternatively, the high-temperature-side heat transfer element 110 may be attached to the radiation shield 40, the low-temperature-side heat transfer element 120 may be attached to the superconducting coil 12, and the heat switch 100 may directly connect the superconducting coil 12 and the radiation shield 40.

The heat switch 100 includes a connecting tube 140 that extends from the high-temperature-side heat transfer element 110 to the low-temperature-side heat transfer element 120 to isolate the gas gap 130 from the surrounding environment (that is, the vacuum region 32) of the heat switch 100. The connecting tube 140 extends along the center axis C2 of the heat switch 100 in a coaxial manner with the high-temperature-side heat transfer element 110 and the low-temperature-side heat transfer element 120. The heat switch 100 constitutes a hermetic container that encloses the working gas in the gas gap 130 by the high-temperature-side heat transfer element 110, the low-temperature-side heat transfer element 120, and the connecting tube 140.

The heat switch 100 can thermally connect the high-temperature side and the low-temperature side to each other by heat transfer between the heat transfer elements via the working gas in the gas gap 130 when the temperatures of the high-temperature-side heat transfer element 110 and the low-temperature-side heat transfer element 120 are higher than a switching temperature. This is an on state of the heat switch 100. The switching temperature of the heat switch 100 corresponds to the boiling point of the enclosed working gas.

The heat switch 100 disconnects the thermal connection between the high-temperature side and the low-temperature side when the temperature of at least one of the high-temperature-side heat transfer element 110 and the low-temperature-side heat transfer element 120 (usually, the low-temperature-side heat transfer element 120) is lower than the switching temperature. This is because the working gas in the gas gap 130 condenses at least on the surface of the low-temperature-side heat transfer element 120, the gas gap 130 becomes a vacuum, and the high-temperature-side heat transfer element 110 and the low-temperature-side heat transfer element 120 are vacuum-insulated via the gas gap 130. This is an off state of the heat switch 100.

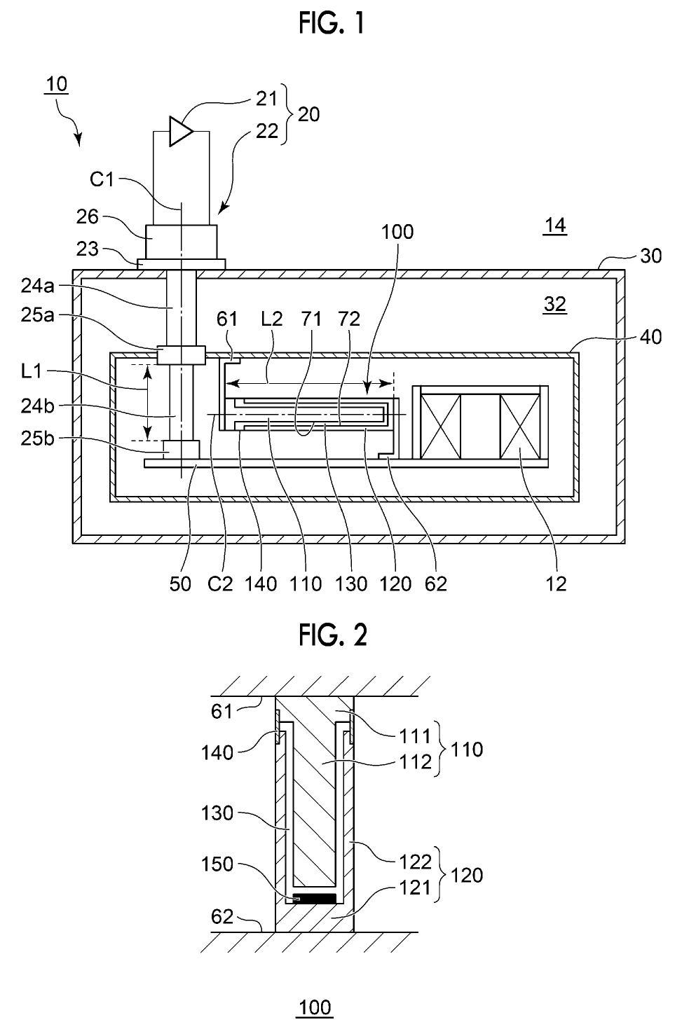

An exemplary configuration of the heat switch 100 that can be mounted on the cryogenic device 10 will be described in more detail with reference to FIGS. 2 to 8.

The cryogenic device 10 according to the embodiment operates as follows. When the cryocooler 20 is activated, the first cooling stage 25a of the cryocooler 20 is cooled to the first cooling temperature, and the second cooling stage 25b is cooled to the second cooling temperature. The radiation shield 40 is cooled to the first cooling temperature by the first cooling stage 25a, and the superconducting coil 12 is cooled to the second cooling temperature by the second cooling stage 25b. By energizing the superconducting coil 12 from a power supply (not shown), the superconducting coil 12 can generate a strong magnetic field. In this way, the cryogenic device 10 can be operated.

Connecting a portion at the first cooling temperature, such as the radiation shield 40, and a portion at the second cooling temperature, such as the superconducting coil 12, with the heat switch 100 is advantageous for initial cooling when the cryogenic device 10 is activated. In the initial cooling, the cryocooler 20 is cooled from an ambient temperature (for example, room temperature) to a target cryogenic temperature. Therefore, at the beginning of the initial cooling, the heat switch 100 is turned on, and the radiation shield 40 and the superconducting coil 12 are thermally connected. In general, the cooling capacity of the first cooling stage 25a of the cryocooler 20 is larger than the cooling capacity of the second cooling stage 25b. Typically, the cooling capacity of the first stage of the cryocooler 20 can reach several tens of times the cooling capacity of the second stage of the cryocooler 20. The cooling capacity of the first cooling stage 25a can be used to assist in the cooling of the superconducting coil 12 by the second cooling stage 25b via the heat switch 100. In this manner, the time required for the initial cooling can be shortened.

Thereafter, the cooling progresses, and when the superconducting coil 12 is cooled to a temperature lower than the switching temperature of the heat switch 100, the heat switch 100 is switched off, and the thermal connection between the radiation shield 40 and the superconducting coil 12 is disconnected. The radiation shield 40 is maintained at the first cooling temperature by the first cooling stage 25a, while the superconducting coil 12 is further cooled by the second cooling stage 25b and is finally cooled to the second cooling temperature.

The existing gas-gap type heat switch is based on a design concept that heat transfer in the on state is realized by relying on natural convection of internal gas. The natural convection is generated by a temperature difference and gravity. The temperature difference is an environmental factor determined according to the application in which the heat switch is installed. Therefore, in order to effectively use gravity to generate natural convection, the existing heat switch needs to be installed along the direction of gravity acting on the heat switch, that is, along a vertical direction.

Such a disposition of the heat switch is illustrated in FIG. 10. As described above, since the cryocooler is also typically installed along the direction of gravity, the existing heat switch is installed parallel to the cryocooler between the first stage and the second stage of the cryocooler in many cases.

In a case where the heat switch is installed in another direction without following this installation requirement, the heat transfer performance that can be exhibited by the existing heat switch may be reduced compared to the designed heat transfer performance. In a case where the heat switch does not operate as designed, as a result, the heat switch may not be able to provide the heat transfer performance required for the application.

In a case where the heat switch is installed parallel to the cryocooler, the dimension of the heat switch in a longitudinal direction is limited by the distance between the first stage and the second stage of the cryocooler. As an example of the cryocooler 20 illustrated in FIG. 1, the length of the existing heat switch requiring parallel installation cannot be longer than a distance L1 between the first cooling stage 25a and the second cooling stage 25b along the center axis C1 of the cryocooler 20. The area of the heat transfer surface inside the heat switch should be correlated with the length of the heat switch. Therefore, the heat transfer performance of the heat switch is constrained by the distance between the first stage and the second stage of the cryocooler.

The present inventors have found, through their own consideration, that it is possible to design a gas-gap type heat switch suitable for practical use in a cryogenic device even by departing from the existing design concept based on heat transfer by natural convection of internal gas. The heat switch 100 according to the embodiment can provide sufficient heat transfer performance by using heat conduction through gas between heat transfer surfaces, rather than relying on natural convection of gas.

The heat switch 100 according to the embodiment does not require natural convection of gas for heat transfer, and thus is not constrained by the above-described installation posture. Therefore, unlike the existing heat switch, the heat switch 100 is allowed to be installed with its center axis C2 directed in a direction different from the direction of gravity acting on the cryogenic device 10. In a case where the cryocooler 20 is installed in the cryogenic device 10 along the direction of gravity, the heat switch 100 is allowed to be installed with its center axis C2 directed in a direction not parallel to the center axis C1 of the cryocooler 20. The heat switch 100 can provide the heat transfer performance as designed regardless of the installation posture. As illustrated in FIG. 1, the present inventors have confirmed through experiments that the initial cooling time of the cryogenic device 10 can be shortened by the effect of the heat switch 100 in a case where the heat switch 100 is installed with the center axis C2 directed in the horizontal direction.

In the existing heat switch, a relatively wide gas gap, for example, 10 mm or more, is set to promote natural convection. On the other hand, the heat switch 100 according to the embodiment utilizes heat conduction of gas present in the gas gap 130, and does not need to use natural convection. Therefore, the gas gap 130 may be narrower than that of the existing heat switch. The spacing between the first heat transfer surface 71 and the second heat transfer surface 72 in the gas gap 130 may be, for example, within 1 mm, and more preferably within 0.5 mm. In this way, natural convection in the gas gap 130 can be suppressed, which is expected to lead to stabilization of the performance of the heat switch 100.

A length L2 of the heat switch 100 in the direction of the center axis C2 of the heat switch 100 may be longer than the distance L1 between the first cooling stage 25a and the second cooling stage 25b along the center axis C1 of the cryocooler 20. As described above, the installation posture of the heat switch 100 need not be aligned with the direction of the cryocooler 20. Therefore, the length L2 of the heat switch 100 can be made longer than the axial distance L1 between the two cooling stages of the cryocooler 20. By making the heat switch 100 longer in this way, the areas of the first heat transfer surface 71 and the second heat transfer surface 72 inside the heat switch can be increased. Efficient heat transfer between the first heat transfer surface 71 and the second heat transfer surface 72 through the gas gap 130 in the on state of the heat switch 100 is possible, and the heat transfer performance of the heat switch 100 is improved.

In addition, the longer the heat switch 100 is, for example, the more the heat input from the first cooling stage 25a to the second cooling stage 25b through the structural material of the heat switch 100, such as the connecting tube 140, can be reduced. The heat insulation performance of the heat switch 100 in the off state is also improved.

FIG. 2 is a schematic cross-sectional view showing an exemplary configuration of the heat switch 100 shown in FIG. 1 in more detail. FIG. 2 shows a longitudinal cross section including the center axis of the heat switch 100. As described above, the heat switch 100 includes the high-temperature-side heat transfer element 110 and the low-temperature-side heat transfer element 120 that is disposed to face the high-temperature-side heat transfer element 110 with the gas gap 130 interposed therebetween. For example, the heat switch 100 may have a substantially cylindrical shape extending along the center axis thereof.

The high-temperature-side heat transfer element 110 includes a first base portion 111 and a pillar portion 112 extending from the first base portion 111. The first base portion 111 is thermally coupled to the first member 61 (for example, the radiation shield 40 or the first cooling stage 25a shown in FIG. 1) that is cooled to the first cooling temperature. The first base portion 111 may have, for example, a substantially disk-like shape, and is fixed to the first member 61 by bringing a circular end surface of the first base portion 111 into contact with a surface of the first member 61. The pillar portion 112 is disposed inside the heat switch 100. The pillar portion 112 has, for example, a cylindrical shape. The pillar portion 112 extends from the first base portion 111 on a side opposite to the first member 61 in a coaxial manner with the first base portion 111 along the center axis of the heat switch 100. The pillar portion 112 may be integrally formed with the first base portion 111, or may be prepared separately from the first base portion 111 and joined to the first base portion 111.

The low-temperature-side heat transfer element 120 includes a second base portion 121 and a tubular portion 122 extending from the second base portion 121. The second base portion 121 is thermally coupled to the second member 62 (for example, the superconducting coil 12 or the second cooling stage 25b shown in FIG. 1) that is cooled to the second cooling temperature. The second base portion 121 may have, for example, a substantially disk-like shape, and is fixed to the second member 62 by bringing a circular end surface of the second base portion 121 into contact with a surface of the second member 62. The tubular portion 122 has, for example, a cylindrical shape. The tubular portion 122 extends from the second base portion 121 on a side opposite to the second member 62 in a coaxial manner with the second base portion 121 along the center axis of the heat switch 100. The tubular portion 122 may be integrally formed with the second base portion 121, or may be prepared separately from the second base portion 121 and joined to the second base portion 121.

The low-temperature-side heat transfer element 120 is configured to receive the high-temperature-side heat transfer element 110 inside. The pillar portion 112 of the high-temperature-side heat transfer element 110 is inserted into a cavity in the tubular portion 122 of the low-temperature-side heat transfer element 120. The second base portion 121 of the low-temperature-side heat transfer element 120 faces the pillar portion 112 of the high-temperature-side heat transfer element 110, and the tubular portion 122 of the low-temperature-side heat transfer element 120 surrounds the pillar portion 112 of the high-temperature-side heat transfer element 110. The pillar portion 112 of the high-temperature-side heat transfer element 110 and the second base portion 121 and the tubular portion 122 of the low-temperature-side heat transfer element 120 are separated by a gas gap 130 and are not in physical contact with each other. The tubular portion 122 of the low-temperature-side heat transfer element 120 is disposed close to the first base portion 111 of the high-temperature-side heat transfer element 110 on a side opposite to the second base portion 121.

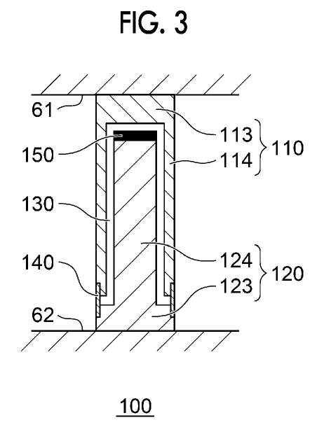

In this way, in a case where the high-temperature-side heat transfer element 110 has the pillar portion 112 and the low-temperature-side heat transfer element 120 has the tubular portion 122, the volume of the low-temperature-side heat transfer element 120 can be smaller than the volume of the high-temperature-side heat transfer element 110. The fact that the low-temperature-side heat transfer element 120 has a relatively small volume leads to a reduction in the heat load on the second cooling stage 25b of the cryocooler 20, and thus can be advantageous (for example, compared to the example of FIG. 3).

In addition, the heat switch 100 includes a connecting tube 140 that forms a hermetic container for enclosing the working gas of the heat switch 100 inside together with the high-temperature-side heat transfer element 110 and the low-temperature-side heat transfer element 120. The connecting tube 140 connects the high-temperature-side heat transfer element 110 and the low-temperature-side heat transfer element 120, and more specifically, connects the tubular portion 122 to the first base portion 111 to isolate the gas gap 130 from the surrounding environment (for example, the vacuum region 32 shown in FIG. 1). The connecting tube 140 has, for example, a cylindrical shape and extends in a coaxial manner with the first base portion 111 and the tubular portion 122 along the center axis of the heat switch 100. The connecting tube 140 may be joined to the high-temperature-side heat transfer element 110 and the low-temperature-side heat transfer element 120 by, for example, brazing, adhesion, or another appropriate joining method.

The axial length of the connecting tube 140 may be considerably shorter than the axial total length of the heat switch 100, and may be, for example, half or less or one-third or less of the axial total length of the heat switch 100. As an example, the connecting tube 140 may have a ring shape (for example, an annular shape) in which the axial length is shorter than the diameter, rather than a cylindrical shape.

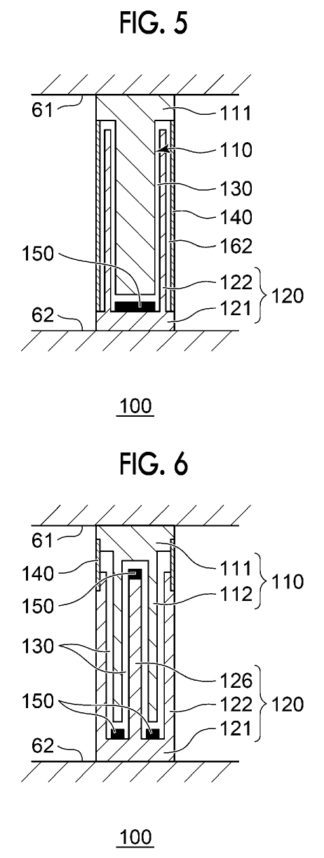

In a design of a certain existing heat switch, a tubular member serving as an outer shell of the heat switch extends over substantially the entire axial length of the heat switch, and two heat transfer bodies spaced apart from each other are connected by the tubular member. Therefore, in such an existing heat switch, a radial gap (for example, a radial gap 162 shown in FIG. 5) is formed between the tubular member and the heat transfer body inside the tubular member. The diameter of the heat transfer body is smaller than the diameter of the tubular member by the amount of the radial gap, and as a result, the surface area of the heat transfer body is also smaller according to the diameter, which can lead to a decrease in the heat transfer performance of the heat switch.

On the other hand, in the present embodiment, the connecting tube 140 is connected in series with the tubular portion 122 of the low-temperature-side heat transfer element 120 in the axial direction. There is no radial gap between the connecting tube 140 and the tubular portion 122. The diameter of the tubular portion 122 is equal to the diameter of the heat switch 100, and the surface area of the tubular portion 122 can be relatively large. This can improve the heat transfer performance of the heat switch 100 as compared with the existing design.

The high-temperature-side heat transfer element 110 and the low-temperature-side heat transfer element 120 are formed of, for example, a metal material such as copper or another material having a high thermal conductivity, as in the other heat transfer members in the cryogenic device 10 described above. The high-temperature-side heat transfer element 110 and the low-temperature-side heat transfer element 120 are usually formed of the same material, but may be formed of different materials.

The connecting tube 140 is formed of a material having a lower thermal conductivity than the high-temperature-side heat transfer element 110 and the low-temperature-side heat transfer element 120, for example, a heat insulating material. Here, the heat insulating material may be a material having a thermal conductivity of, for example, 1/10 or less of the thermal conductivity of the high thermal conductivity material forming the high-temperature-side heat transfer element 110 (or the low-temperature-side heat transfer element 120). The connecting tube 140 may be formed of, for example, stainless steel, glass fiber reinforced plastic (GFRP), or another plastic material. As a result, it is possible to prevent or minimize heat intrusion from the high-temperature-side heat transfer element 110 to the low-temperature-side heat transfer element 120 through the connecting tube 140 when the heat switch 100 is off.

Since the material forming the connecting tube 140 usually has a higher strength than the high thermal conductivity material forming the heat transfer element, the wall thickness of the connecting tube 140 may be thinner than the wall thickness of the tubular portion 122 of the heat transfer element, as shown in the drawing. Reducing the wall thickness of the connecting tube 140 in this way helps to suppress heat intrusion from the high-temperature-side heat transfer element 110 to the low-temperature-side heat transfer element 120 through the connecting tube 140.

The working gas enclosed in the heat switch 100 is selected such that the switching temperature of the heat switch 100 is lower than the first cooling temperature of the cryocooler 20 and higher than the second cooling temperature. As described above, the switching temperature of the heat switch 100 corresponds to the boiling point of the enclosed working gas. Therefore, the working gas enclosed in the heat switch 100 may be, for example, neon (approximately 27.1 K). Alternatively, the working gas may be hydrogen (approximately 20.4 K) or helium (approximately 4.2 K). Here, the value added in parentheses for each gas species is the boiling point of that gas species at atmospheric pressure. For example, when neon is enclosed in the heat switch 100 as the working gas at atmospheric pressure, the switching temperature of the heat switch 100 can be set to approximately 27.1 K. The working gas may be enclosed in the heat switch 100 at a pressure higher than atmospheric pressure (for example, within 5 atmospheres or within 10 atmospheres). The switching temperature of the heat switch 100 may be adjusted by adjusting the filling pressure of the working gas.

The working gas may be a mixed gas, for example, a mixed gas containing at least one of neon, hydrogen, or helium. The mixed gas may contain, for example, a diluent gas such as nitrogen, argon, or air. The switching temperature of the heat switch 100 may be adjusted by adjusting the composition of the mixed gas.

Optionally, the heat switch 100 may include a getter material 150 that is thermally coupled to the low-temperature-side heat transfer element 120 and that is capable of adsorbing gas from the gas gap 130. The getter material 150 may be, for example, activated carbon or another porous material, or another adsorbent material having an adsorption capacity for the working gas of the heat switch 100 at cryogenic temperatures (that is, at a temperature equal to or lower than the switching temperature of the heat switch 100, for example, the second cooling temperature). The getter material 150 is installed on the surface of the low-temperature-side heat transfer element 120 by an appropriate method such that the getter material 150 can be cooled by the low-temperature-side heat transfer element 120.

Ideally, when the heat switch 100 is cooled to a temperature lower than the switching temperature, the working gas condenses in the heat switch 100 as described above, the gas gap 130 becomes a vacuum, and the heat switch 100 is turned off. However, in practice, some of the working gas may remain in the gas gap 130. Such residual gas may cause heat transfer between the high-temperature-side heat transfer element 110 and the low-temperature-side heat transfer element 120. Undesirably, heat intrusion from the high-temperature-side heat transfer element 110 to the low-temperature-side heat transfer element 120 through the heat switch 100, which should be off, may become non-negligible.

On the other hand, by providing the getter material 150 in the heat switch 100, the residual gas can be adsorbed, and the degree of vacuum of the gas gap 130 can be further increased. Therefore, it is possible to more reliably achieve disconnection of the thermal connection in the off state of the heat switch 100.

The getter material 150 is disposed on the low-temperature-side heat transfer element 120 to face the gas gap 130. As a result, the getter material 150 is exposed to the residual gas that may be present in the gas gap 130, and can efficiently adsorb the residual gas. In addition, by directly cooling the getter material 150 with the low-temperature-side heat transfer element 120, the temperature of the getter material 150 can be quickly lowered. As a result, the heat switch 100 can be quickly switched to the off state, and a heat switch 100 having excellent responsiveness can be provided.

In the illustrated example, the getter material 150 is provided on a surface of the second base portion 121 of the low-temperature-side heat transfer element 120, the surface facing the pillar portion 112 of the high-temperature-side heat transfer element 110. Instead of or together with this, the getter material 150 can also be disposed on the low-temperature-side heat transfer element 120 in other ways. For example, the getter material 150 may be installed on an inner surface of the tubular portion 122 facing a circumferential surface of the pillar portion 112.

The heat switch 100 is a so-called one-gap (single gap) type heat switch, and the gas gap 130 is the only gas gap of the heat switch 100. The one-gap type heat switch has an advantage in that it is easier to manufacture and assemble than a multi-gap type heat switch described later.

In the exemplary heat switch 100 described with reference to FIG. 2, the high-temperature-side heat transfer element 110 has a protruding shape, and the low-temperature-side heat transfer element 120 has a recessed shape that receives the high-temperature-side heat transfer element 110. However, as an alternative, in any of the embodiments described in this specification, as will be described later with reference to FIG. 3, the high-temperature-side heat transfer element 110 may have a recessed shape, and the low-temperature-side heat transfer element 120 may have a corresponding protruding shape.

FIG. 3 is a schematic view showing a heat switch 100 according to a modification example. The heat switch 100 includes the high-temperature-side heat transfer element 110 and the low-temperature-side heat transfer element 120 that is disposed to face the high-temperature-side heat transfer element 110 with the gas gap 130 interposed therebetween. The high-temperature-side heat transfer element 110 and the low-temperature-side heat transfer element 120 are connected to each other by a connecting tube 140.

As shown in FIG. 3, the low-temperature-side heat transfer element 120 may include a first base portion 123 and a pillar portion 124 extending from the first base portion 123. The high-temperature-side heat transfer element 110 may include a second base portion 113 facing the pillar portion 124 and a tubular portion 114 extending from the second base portion 113 to surround the pillar portion 124. The tubular portion 114 is connected to the first base portion 123 by the connecting tube 140. Even in this way, it is possible to provide a one-gap type heat switch.

Optionally, a getter material 150 may be provided in the heat switch 100. The getter material 150 may be installed, for example, on a distal end surface of the pillar portion 124 of the low-temperature-side heat transfer element 120. The getter material 150 may be installed on the circumferential surface of the pillar portion 124 of the low-temperature-side heat transfer element 120.

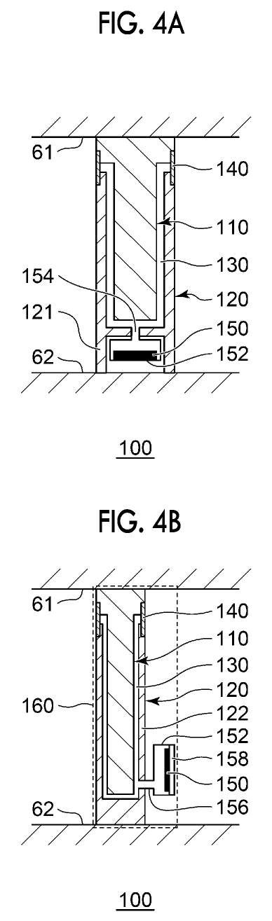

FIGS. 4A and 4B are schematic views showing a heat switch 100 according to a modification example. The heat switch 100 includes the high-temperature-side heat transfer element 110 and the low-temperature-side heat transfer element 120 that is disposed to face the high-temperature-side heat transfer element 110 with the gas gap 130 interposed therebetween. The high-temperature-side heat transfer element 110 has a protruding shape, and the low-temperature-side heat transfer element 120 has a recessed shape that receives the high-temperature-side heat transfer element 110. The high-temperature-side heat transfer element 110 and the low-temperature-side heat transfer element 120 are connected to each other by a connecting tube 140. The heat switch 100 is a one-gap type heat switch.

As shown in FIG. 4A, the heat switch 100 includes a getter chamber 152 having a getter material 150 therein. The getter chamber 152 is accommodated in the low-temperature-side heat transfer element 120, for example, in the second base portion 121 of the low-temperature-side heat transfer element 120. The second base portion 121 has a recessed portion on an end surface of the heat switch 100 that faces the outside opposite to the high-temperature-side heat transfer element 110, and the getter chamber 152 is disposed in the recessed portion. When the low-temperature-side heat transfer element 120 is attached to the second member 62, the getter chamber 152 does not interfere with the second member 62, which is advantageous.

The getter chamber 152 is connected to the gas gap 130 through an internal passage 154 in the heat switch 100. The internal passage 154 is formed in the low-temperature-side heat transfer element 120. As an example, the internal passage 154 may be a through-hole that penetrates the second base portion 121 on the center axis of the heat switch 100. Therefore, the residual gas in the gas gap 130 can enter the getter chamber 152 through the internal passage 154 and be adsorbed by the getter material 150.

As shown in FIG. 4B, the heat switch 100 includes a getter chamber 152 having a getter material 150 therein. The getter chamber 152 is disposed outside the heat switch 100 and is connected to the gas gap 130 through an external passage 156. Since the getter chamber 152 is within the axial range of the heat switch 100, when the heat switch 100 is attached to the first member 61 and the second member 62, the getter chamber 152 can avoid interference with these members.

The getter chamber 152 may be a container that accommodates the getter material 150, and the external passage 156 may be a pipe that connects the getter chamber 152 to the heat switch 100. The getter chamber 152 is thermally coupled to the low-temperature-side heat transfer element 120 via the external passage 156. In order to efficiently cool the getter material 150, the getter chamber 152 and the external passage 156 are formed of, for example, a metal material such as copper or other materials having a high thermal conductivity. As an example, one end of the external passage 156 is attached to the getter chamber 152, and the other end is attached to the tubular portion 122 of the low-temperature-side heat transfer element 120. The residual gas in the gas gap 130 can enter the getter chamber 152 through the external passage 156 and be adsorbed by the getter material 150.

A heater or other temperature regulator 158 may be attached to the getter chamber 152. In this case, by operating the temperature regulator 158 to heat the getter material 150, the working gas that has been adsorbed can be released from the getter material 150 to the gas gap 130. In order to efficiently heat the getter material 150 by the temperature regulator 158, the getter chamber 152 and the external passage 156 may be formed of, for example, a metal material having a relatively low thermal conductivity, such as stainless steel. In addition, by stopping the temperature regulator 158 and cooling the getter material 150 with the low-temperature-side heat transfer element 120, the working gas can be adsorbed by the getter material 150 again. In this way, the heat switch 100 can be switched on and off independently of the cooling operation of the cryocooler 20.

In a case where the heat switch 100 is installed in the cryogenic device 10, various other devices can actually be installed around the heat switch 100. Therefore, as schematically shown by a broken line in FIG. 4B, a predetermined installable area 160 can be set for the heat switch 100.

The heat switch 100 incorporating the getter material 150 according to the embodiment of FIGS. 2 and 4A can increase the diameters of the high-temperature-side heat transfer element 110 and the low-temperature-side heat transfer element 120 as compared with the heat switch 100 having the external getter chamber 152 according to the embodiment of FIG. 4B. In other words, in the embodiment of FIG. 4B, in order to accommodate the heat switch 100 in the installable area 160, the diameters of the high-temperature-side heat transfer element 110 and the low-temperature-side heat transfer element 120 have to be reduced by an amount corresponding to the size of the external getter chamber 152. The heat transfer areas of the high-temperature-side heat transfer element 110 and the low-temperature-side heat transfer element 120 of the heat switch 100 are increased or decreased according to the diameters. Therefore, the heat switch 100 incorporating the getter material 150 has an advantage in that the area of the heat transfer element that can be secured in the high-temperature-side heat transfer element 110 can be relatively large with respect to the size (volume) of a certain predetermined installable area 160.

FIG. 5 is a schematic view showing a heat switch 100 according to a modification example. The heat switch 100 includes the high-temperature-side heat transfer element 110 and the low-temperature-side heat transfer element 120 that is disposed to face the high-temperature-side heat transfer element 110 with the gas gap 130 interposed therebetween. The high-temperature-side heat transfer element 110 has a protruding shape, and the low-temperature-side heat transfer element 120 has a recessed shape that receives the high-temperature-side heat transfer element 110. The high-temperature-side heat transfer element 110 and the low-temperature-side heat transfer element 120 are connected to each other by a connecting tube 140. The heat switch 100 is a one-gap type heat switch.

In the heat switch 100 shown in FIG. 5, the connecting tube 140 is relatively long and extends over substantially the entire length of the heat switch in the axial direction. The connecting tube 140 connects the first base portion 111 of the high-temperature-side heat transfer element 110 to the second base portion 121 of the low-temperature-side heat transfer element 120. The tubular portion 122 of the low-temperature-side heat transfer element 120 is disposed on a radially inner side with respect to the connecting tube 140, and a radial gap 162 is formed between the connecting tube 140 and the tubular portion 122. The pillar portion 112 of the high-temperature-side heat transfer element 110 is inserted into the tubular portion 122 of the low-temperature-side heat transfer element 120, and the gas gap 130 is formed between the pillar portion 112 and the tubular portion 122.

As in the above-described embodiment, the heat switch 100 may include the getter material 150 that is thermally coupled to the low-temperature-side heat transfer element 120 and that is capable of adsorbing the gas from the gas gap 130. The getter material 150 is disposed on the low-temperature-side heat transfer element 120 to face the gas gap 130. For example, the getter material 150 may be provided on the surface of the second base portion 121 of the low-temperature-side heat transfer element 120 that faces the pillar portion 112 of the high-temperature-side heat transfer element 110. Instead of or together with this, the getter material 150 may be provided on another surface of the low-temperature-side heat transfer element 120, for example, on a tip part of the tubular portion 122 of the low-temperature-side heat transfer element 120.

FIG. 6 is a schematic view showing a heat switch 100 according to a modification example. The heat switch 100 includes the high-temperature-side heat transfer element 110 and the low-temperature-side heat transfer element 120 that is disposed to face the high-temperature-side heat transfer element 110 with the gas gap 130 interposed therebetween. The heat switch 100 shown in FIG. 6 is a multi-gap type heat switch having a plurality of gas gaps 130. The multi-gap type heat switch is advantageous in that the heat transfer area is likely to be increased as compared with the one-gap type heat switch.

The high-temperature-side heat transfer element 110 includes a first base portion 111 and a pillar portion 112 extending from the first base portion 111. However, unlike the embodiment shown in FIG. 2, the pillar portion 112 is hollow. The low-temperature-side heat transfer element 120 includes the second base portion 121 and the tubular portion 122 that extends from the second base portion 121. However, unlike the embodiment shown in FIG. 2, a shaft portion 126 that extends from the second base portion 121 is formed in the tubular portion 122 in a coaxial manner with the tubular portion 122. The connecting tube 140 connects the tubular portion 122 to the first base portion 111.

The low-temperature-side heat transfer element 120 is configured to receive the high-temperature-side heat transfer element 110 inside. The pillar portion 112 of the high-temperature-side heat transfer element 110 is inserted into a cavity in the tubular portion 122 of the low-temperature-side heat transfer element 120. In this case, the shaft portion 126 of the low-temperature-side heat transfer element 120 is inserted into a hollow portion of the pillar portion 112. In this way, one gas gap 130 is formed on an inner side of the pillar portion 112 of the high-temperature-side heat transfer element 110, and another gas gap 130 is formed on an outer side of the pillar portion 112. The high-temperature-side heat transfer element 110 and the low-temperature-side heat transfer element 120 are separated by the gas gaps 130 and are not in physical contact with each other.

As in the above-described embodiment, the heat switch 100 may include the getter material 150 that is thermally coupled to the low-temperature-side heat transfer element 120 and that is capable of adsorbing the gas from the gas gap 130. The getter material 150 is disposed on the low-temperature-side heat transfer element 120 to face the gas gap 130. For example, the getter material 150 may be provided on a surface of the shaft portion 126 of the low-temperature-side heat transfer element 120 that faces the first base portion 111 of the high-temperature-side heat transfer element 110. Instead of or together with this, the getter material 150 may be provided on a surface of the second base portion 121 of the low-temperature-side heat transfer element 120 that faces the pillar portion 112 of the high-temperature-side heat transfer element 110. Instead of or together with this, the getter material 150 may be provided on another surface of the low-temperature-side heat transfer element 120.

In the embodiment of FIG. 6, the pillar portion 112 of the high-temperature-side heat transfer element 110 can also be regarded as a cylindrical heat transfer fin. Therefore, the high-temperature-side heat transfer element 110 may have a cylindrical heat transfer fin that extends toward the low-temperature-side heat transfer element 120. In addition, the high-temperature-side heat transfer element 110 may have a plurality of cylindrical fins provided coaxially. The low-temperature-side heat transfer element 120 may have at least one cylindrical fin arranged alternately with the plurality of cylindrical fins of the high-temperature-side heat transfer element 110. In this way, a multi-gap type heat switch having more gas gaps 130 may be configured.

Alternatively, the high-temperature-side heat transfer element 110 may include at least one heat transfer fin having a flat plate shape or another shape that extends toward the low-temperature-side heat transfer element 120, and the low-temperature-side heat transfer element 120 may include at least one heat transfer fin that extends toward the high-temperature-side heat transfer element 110. The at least one heat transfer fin of the high-temperature-side heat transfer element 110 and the at least one heat transfer fin of the low-temperature-side heat transfer element 120 may be disposed alternately to form a plurality of gas gaps 130 in the heat switch 100.

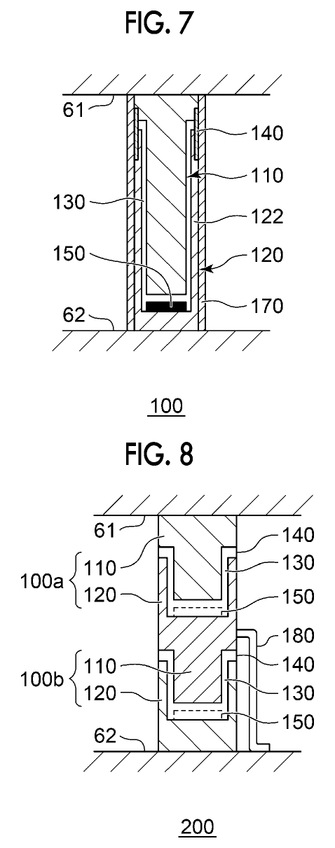

FIG. 7 is a schematic view showing a heat switch 100 according to a modification example. The heat switch 100 includes the high-temperature-side heat transfer element 110 and the low-temperature-side heat transfer element 120 that is disposed to face the high-temperature-side heat transfer element 110 with the gas gap 130 interposed therebetween. The high-temperature-side heat transfer element 110 has a protruding shape, and the low-temperature-side heat transfer element 120 has a recessed shape that receives the high-temperature-side heat transfer element 110. The high-temperature-side heat transfer element 110 and the low-temperature-side heat transfer element 120 are connected to each other by a connecting tube 140. The heat switch 100 is a one-gap type heat switch.

As shown in FIG. 7, the heat switch 100 includes a covering material 170 that covers an outer peripheral surface of the heat switch 100. The covering material 170 covers the tubular portion 122 of the low-temperature-side heat transfer element 120 and an outer peripheral surface of the connecting tube 140. Due to thermal contraction associated with cryogenic cooling, a relative displacement may occur between the first member 61 and the second member 62, and as a result, a load (for example, a lateral load) may be applied to the heat switch 100. The covering material 170 can help reinforce the heat switch 100 against such a load. In order to reduce heat intrusion from the high-temperature-side heat transfer element 110 to the low-temperature-side heat transfer element 120 through the covering material 170, the covering material 170 may be formed of a heat insulating material.

FIG. 8 is a schematic view showing a heat switch device 200 according to an embodiment. The heat switch device 200 includes a plurality of heat switches (in this example, two heat switches 100a and 100b) connected in series. Each of the plurality of heat switches includes the high-temperature-side heat transfer element 110 and the low-temperature-side heat transfer element 120 that is disposed to face the high-temperature-side heat transfer element 110 with the gas gap 130 interposed therebetween. The high-temperature-side heat transfer element 110 has a protruding shape, and the low-temperature-side heat transfer element 120 has a recessed shape that receives the high-temperature-side heat transfer element 110. The high-temperature-side heat transfer element 110 and the low-temperature-side heat transfer element 120 are connected to each other by a connecting tube 140.

As shown in FIG. 8, the high-temperature-side heat transfer element 110 of one heat switch 100a of two adjacent heat switches is thermally coupled to the first member 61. The low-temperature-side heat transfer element 120 of the other heat switch 100b of the two adjacent heat switches is thermally coupled to the second member 62.

The low-temperature-side heat transfer element 120 of the high-temperature-side heat switch 100a and the high-temperature-side heat transfer element 110 of the low-temperature-side heat switch 100b may be integrated. The integrated heat transfer element is thermally coupled to the second member 62, for example, via a heat transfer member 180.

Alternatively, the low-temperature-side heat transfer element 120 of the high-temperature-side heat switch 100a and the high-temperature-side heat transfer element 110 of the low-temperature-side heat switch 100b may be thermally coupled to each other. In other words, each of the plurality of heat switches may be the heat switch 100 according to any of the above-described embodiments, and such heat switches 100 may be simply stacked in the axial direction. The low-temperature-side heat transfer element 120 of each heat switch 100 is thermally coupled to the second member 62 together with the high-temperature-side heat transfer element 110 of the adjacent heat switch 100 that is thermally coupled thereto.

In a case where the heat switch device 200 has a plurality of heat switches connected in series, the thermal connection between the first member 61 and the second member 62 is cut off by turning off any heat switch. Even in a case where any heat switch of the plurality of heat switches is not switched off due to some defect (for example, physical contact between the high-temperature-side heat transfer element 110 and the low-temperature-side heat transfer element 120, presence of excessive residual gas, or the like), the heat switch device 200 can cut off the thermal connection between the first member 61 and the second member 62 by any other heat switch being normally switched off. Therefore, the heat switch device 200 is advantageous in that it is more robust against defects than a single heat switch 100.

Therefore, it is not necessary to provide the getter material 150 in each heat switch of the heat switch device 200. However, as in the above-described embodiment, the getter material 150 may be provided in each heat switch as indicated by a broken line.

A situation in which the heat switch device 200 is turned on is considered. In a case where a single heat switch 100 is installed in an installable area having a certain size and a case where the heat switch device 200 is installed, the size of each heat switch constituting the heat switch device 200 is smaller than the size of the single heat switch 100, but the total heat transfer area is substantially the same. Therefore, it is expected that the heat transfer performance of the single heat switch 100 and the heat switch device 200 is substantially the same. In addition, the total axial length of the connecting tube 140 of each heat switch in the heat switch device 200 is substantially equal to the axial length of the connecting tube 140 of the single heat switch 100. Therefore, it is expected that the heat insulation performance of the single heat switch 100 and the heat switch device 200 is substantially the same.

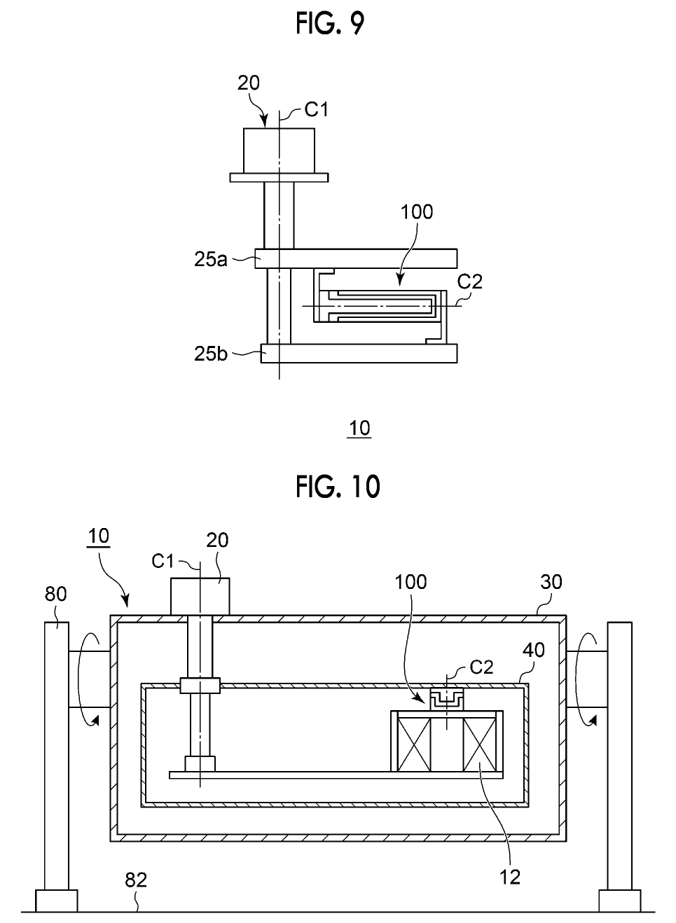

FIG. 9 is a view schematically showing a cryogenic device 10 according to another embodiment. The cryogenic device 10 includes a cryocooler 20 and a heat switch 100 that is mounted on the cryocooler 20 and that connects a first cooling stage 25a and a second cooling stage 25b. As in the above-described embodiment, the center axis C2 of the heat switch 100 extends in a direction that is not parallel to the center axis C1 of the cryocooler 20, for example, in a direction perpendicular to the center axis C1. The cooling capacity of the first cooling stage 25a can be used to assist in the cooling of an object to be cooled, such as a superconducting coil, by the second cooling stage 25b via the heat switch 100. In this manner, the time required for the initial cooling can be shortened.

FIG. 10 is a view schematically showing a cryogenic device 10 according to another embodiment. As in the above-described embodiment, the cryogenic device 10 includes an object to be cooled, such as a superconducting coil 12, the cryocooler 20, a vacuum vessel 30, a radiation shield 40, and a heat switch 100. The center axis C2 of the heat switch 100 is parallel to the center axis C1 of the cryocooler 20. Alternatively, as in the above-described embodiment, the center axis C2 of the heat switch 100 may extend in a direction that is not parallel to the center axis C1 of the cryocooler 20, for example, in a direction perpendicular to the center axis C1.

However, the vacuum vessel 30 includes a rotation mechanism 80 configured to rotate the vacuum vessel 30 around at least one axis, and is rotatable with respect to a floor surface 82. A rotation axis of the vacuum vessel 30 by the rotation mechanism 80 may be, for example, parallel to the floor surface 82. The angle posture of the vacuum vessel 30 with respect to the floor surface 82 can be changed by the rotation mechanism 80. The direction of the center axis C2 of the heat switch 100 is determined according to the angle posture of the vacuum vessel 30 adjusted by the rotation mechanism 80.

As described above, since the existing gas-gap type heat switch uses natural convection of internal gas for heat transfer, it is necessary to install the heat switch along the vertical direction. Therefore, the existing heat switch is not suitable for the rotatable vacuum vessel 30 in which the installation posture is not fixed. On the other hand, the heat switch 100 according to the embodiment can exhibit good heat transfer performance regardless of the installation posture, and thus can be mounted on the rotatable vacuum vessel 30.

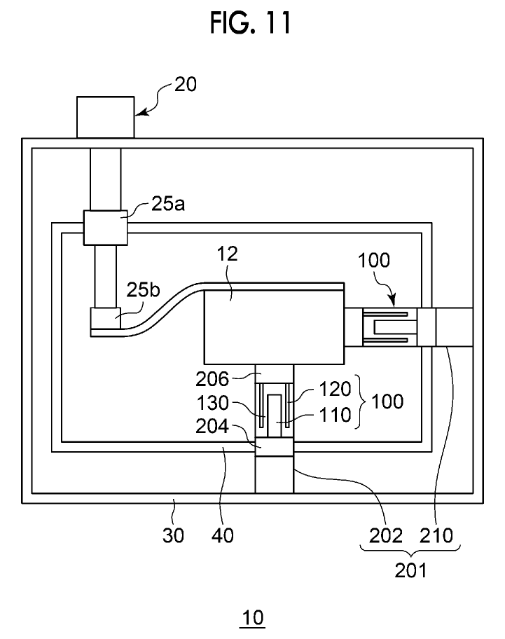

FIG. 11 is a view schematically showing a cryogenic device 10 according to another embodiment. As in the above-described embodiment, the cryogenic device 10 includes an object to be cooled, such as a superconducting coil 12, the cryocooler 20, a vacuum vessel 30, a radiation shield 40, and a heat switch 100.

The heat switch 100 may be disposed in the vacuum vessel 30 and applied to a support structure 201 that supports the object to be cooled on the vacuum vessel 30. The support structure 201 may include a vertical support 202, and the heat switch 100 may be incorporated into the vertical support 202.

The vertical support 202 is fixed to the vacuum vessel 30, extends through the radiation shield 40 in the vertical direction, and abuts against the object to be cooled such as the superconducting coil 12. The vertical support 202 can support, for example, a force that acts vertically downward on the object to be cooled, such as the weight of the superconducting coil 12 itself. A support such as the vertical support 202 is formed of a heat insulating material such as a fiber-reinforced plastic (FRP). Alternatively, the support may be formed of a material having a lower thermal conductivity than a high thermal conductivity material that forms a heat transfer path in the cryogenic device 10, such as stainless steel.

A first heat transfer stage 204 and a second heat transfer stage 206 may be installed on the vertical support 202. The first heat transfer stage 204 is fixed to the radiation shield 40 (or connected to the radiation shield 40 via an appropriate heat transfer member), and is thermally coupled to the first cooling stage 25a of the cryocooler 20 via the radiation shield 40. The second heat transfer stage 206 is fixed to the superconducting coil 12 (or connected to the superconducting coil 12 via an appropriate heat transfer member), and is thermally coupled to the second cooling stage 25b of the cryocooler 20 via the superconducting coil 12. Therefore, the first heat transfer stage 204 is cooled to a first cooling temperature by the first cooling stage 25a, and the second heat transfer stage 206 is cooled to a second cooling temperature by the second cooling stage 25b.

The heat switch 100 is configured to thermally couple the second heat transfer stage 206 to the first heat transfer stage 204 when the temperature of the second heat transfer stage 206 exceeds the switching temperature of the heat switch 100, and to thermally decouple the second heat transfer stage 206 from the first heat transfer stage 204 when the temperature of the second heat transfer stage 206 falls below the switching temperature. The heat switch 100 includes a high-temperature-side heat transfer element 110 that is thermally coupled to the first heat transfer stage 204, and a low-temperature-side heat transfer element 120 that is thermally coupled to the second heat transfer stage 206. The high-temperature-side heat transfer element 110 and the low-temperature-side heat transfer element 120 are disposed to face each other with a gas gap 130 for heat exchange via the working gas of the heat switch 100 interposed therebetween. The high-temperature-side heat transfer element 110 and the low-temperature-side heat transfer element 120 are not in contact with each other.

As described above, the working gas enclosed in the heat switch 100 is selected such that the switching temperature of the heat switch 100 is lower than the first cooling temperature of the cryocooler 20 and higher than the second cooling temperature. Optionally, the heat switch 100 may include a getter material that is thermally coupled to the second heat transfer stage 206 and that is capable of adsorbing gas from an airtight space in the heat switch 100.

In addition, the support structure 201 may include a lateral support 210. The lateral support 210 is fixed to the vacuum vessel 30, extends through the radiation shield 40 in the horizontal direction, and abuts against the object to be cooled. The lateral support 210 can support a force acting in the horizontal direction on the object to be cooled, such as an electromagnetic force acting on the superconducting coil 12. In the same manner as the vertical support 202, the heat switch 100 may be incorporated into the lateral support 210.

Even in the present embodiment, during the initial cooling of the cryogenic device 10, the cooling capacity of the first cooling stage 25a can be used to assist in the cooling of the superconducting coil 12 by the second cooling stage 25b via the heat switch 100 in the on state. In this manner, the time required for the initial cooling can be shortened. In addition, since the heat switch 100 is switched off as the initial cooling is completed, the first heat transfer stage 204 and the radiation shield 40 can be maintained at the first cooling temperature by the first cooling stage 25a, and the second heat transfer stage 206 and the superconducting coil 12 can be cooled to the second cooling temperature by the second cooling stage 25b.

In addition, in the present embodiment, the heat switch 100 is incorporated into the support structure 201. The heat leak from the vacuum vessel 30 to the superconducting coil 12 through the support structure 201 is unchanged regardless of the presence or absence of the heat switch 100. Therefore, it is advantageous in that an increase in heat leak due to the addition of the heat switch 100 does not occur.

The present invention has been described hereinbefore based on the examples. The present invention is not limited to the above-described embodiment, and various design changes are possible, and it will be understood by those skilled in the art that various modification examples are possible and such modification examples also fall within the scope of the present invention. Various features described in relation to a certain embodiment are also applicable to other embodiments. A new embodiment resulting from combination will have the effects of the respective embodiments that are combined.

In the above-described embodiment, a case where one heat switch 100 is installed in the cryogenic device 10 has been described as an example, but the present invention is not limited thereto. For example, the cryogenic device 10 may include a plurality of heat switches 100, and each of the heat switches 100 may connect a portion at the first cooling temperature, such as the radiation shield 40, and a portion at the second cooling temperature, such as the superconducting coil 12. In addition, the cryocooler 20 may include a plurality of heat switches 100, and each of the heat switches 100 may connect the first cooling stage 25a and the second cooling stage 25b.

In the above-described embodiment, a case where the cryocooler 20 is a multistage Gifford-McMahon refrigerator has been described as an example, but the present invention is not limited thereto. The cryocooler 20 may be a pulse tube cryocooler, a Stirling cryocooler, or another type of multistage cryocooler.

In the above-described embodiment, a case where the cryogenic device 10 is of a conduction-cooled type in which an object to be cooled is directly cooled by the cryocooler 20 has been described as an example, but the present invention is not limited thereto. The cryogenic device 10 may be of an immersion-cooled type in which an object to be cooled is immersed in and cooled by a cryogenic refrigerant such as liquid helium.

Although the present invention has been described using specific words and phrases based on the embodiment, the embodiment merely shows one aspect of the principle and application of the present invention, and many modification examples and changes in disposition may be made to the embodiment without departing from the concept of the present invention specified in the claims.

The present invention can be used in the field of cryogenic devices.

It should be understood that the invention is not limited to the above-described embodiment, but may be modified into various forms on the basis of the spirit of the disclosure. Additionally, the modifications are included in the scope of the disclosure.

What is claimed is:

1. A cryogenic device comprising:
a cryocooler including a first cooling stage and a second cooling stage that are disposed along a center axis of the cryocooler, in which the second cooling stage is cooled to a lower temperature than the first cooling stage; and
a heat switch that thermally connects the first cooling stage and the second cooling stage to each other or that disconnects the thermal connection between the first cooling stage and the second cooling stage, the heat switch extending along a direction that is not parallel to the center axis of the cryocooler.

2. The cryogenic device according to claim 1, wherein the heat switch extends along a direction perpendicular to the center axis of the cryocooler.

3. The cryogenic device according to claim 2, wherein the center axis of the cryocooler is disposed along a direction of gravity acting on the cryogenic device, and the heat switch extends in a horizontal direction.

4. The cryogenic device according to claim 1, wherein the direction that is not parallel to the center axis of the cryocooler is a direction different from a direction of gravity acting on the cryogenic device.

5. The cryogenic device according to claim 1, wherein a length of the heat switch in the direction that is not parallel to the center axis of the cryocooler is longer than a distance between the first cooling stage and the second cooling stage along the center axis of the cryocooler.

6. The cryogenic device according to claim 1, wherein the heat switch includes
a first heat transfer element that is thermally coupled to the first cooling stage,
a second heat transfer element that is thermally coupled to the second cooling stage and that is disposed to face the first heat transfer element with a gas gap interposed between the first heat transfer element and the second heat transfer element, and
a connecting tube that extends from the first heat transfer element to the second heat transfer element along the direction that is not parallel to the center axis of the cryocooler to isolate the gas gap from a surrounding environment of the heat switch.

7. The cryogenic device according to claim 6, wherein the first heat transfer element has a first heat transfer surface that faces the gas gap and that extends along the direction that is not parallel to the center axis of the cryocooler, and
the second heat transfer element has a second heat transfer surface that faces the gas gap and that extends along the direction that is not parallel to the center axis of the cryocooler.

8. The cryogenic device according to claim 7, wherein a spacing between the first heat transfer surface and the second heat transfer surface in the gas gap is within 1 mm.

9. The cryogenic device according to claim 6, wherein the heat switch further includes a getter material that is thermally coupled to the second heat transfer element and that adsorbs gas from the gas gap.

10. The cryogenic device according to claim 9, wherein the getter material is accommodated in a getter chamber accommodated in the second heat transfer element, and the getter chamber is connected to the gas gap through an internal passage formed in the second heat transfer element.

11. The cryogenic device according to claim 1, further comprising a rotatable vacuum vessel in which the cryocooler is installed and in which the heat switch is accommodated together with the first cooling stage and the second cooling stage.

12. A cryogenic device comprising:
a cryocooler including a first cooling stage and a second cooling stage, in which the second cooling stage is cooled to a lower temperature than the first cooling stage; and
a heat switch that thermally connects the first cooling stage and the second cooling stage to each other or that disconnects the thermal connection between the first cooling stage and the second cooling stage, the heat switch extending along a direction that is different from a direction of gravity acting on the cryogenic device.

13. A cryogenic device comprising:
a cryocooler that includes a first cooling stage and a second cooling stage, in which the second cooling stage is cooled to a lower temperature than the first cooling stage;
a heat switch that thermally connects the first cooling stage and the second cooling stage to each other or that disconnects the thermal connection between the first cooling stage and the second cooling stage; and
a rotatable vacuum vessel in which the cryocooler is installed and in which the heat switch is accommodated together with the first cooling stage and the second cooling stage.
